(19) United States
(12) Patent Application Publication
(10) Pub. No.: US 2009/0165260 A1
(43) Pub. Date: Jul. 2, 2009

(54) Paper clip with dual central wire loops

(76) Inventors: Kun Yuan Tong, Suwanee, GA (US); David Tong, Atlanta, GA (US)

Correspondence Address: Kun Yuan Tong, 2842 Lowe Court, Suwanee, GA, 30024, US

(21) Appl. No.: 12/006,131

(22) Filed: Dec. 31, 2007

(51) Int. Cl. B42F 1/02

(52) U.S. Cl. 24/67.9

(57) ABSTRACT

A paper clip with dual central wire loops is made of wire and consists of two central wire loops with or without one mutual central stem in the center. User can grasp it at either end and uses it like using Jem clip or pushes up the central mutual stem if there is any to open one of the two central wire loops to clip papers.

### THE BACKGROUND OF THE INVENTION

Jem paper clip has only one wire loop in the center. Therefore Jem paper clip can only clip papers from the direction of central wire loop. If he/she picks up Jem clip at the wrong end he/she has to turn it to the direction of central wire loop to clip papers. The Present invented paper clip with dual central wire loops has two wire loops in the center and can clip papers from every end.

### THE BRIEF SUMMARY OF THE INVENTION

The present invented paper clip with dual central wire loops has two wire loops in the center. User can pick up this paper clip with dual central wire loops at every end to clip to clip papers.

### THE DETAILED DESCRIPTION OF THE DRAWINGS

FIG. 1 is a perspective view of a paper clip with dual central wire loops.

FIG. 2 is a perspective view of a Jem paper clip.

FIG. 3 is a perspective view of a paper clip with other kind of dual central wire loops.

FIG. 4 is a perspective view of a paper clip with other kind of dual central wire loops.

FIG. 5 is a perspective view of a paper clip with other kind of dual central wire loops.

FIG. 6 is a perspective view of a paper clip with other kind of dual central wire loops.

FIG. 7 is a perspective view of a paper clip with other kind of dual central wire loops.

### THE DETAILED DESCRIPTION OF THE INVENTION

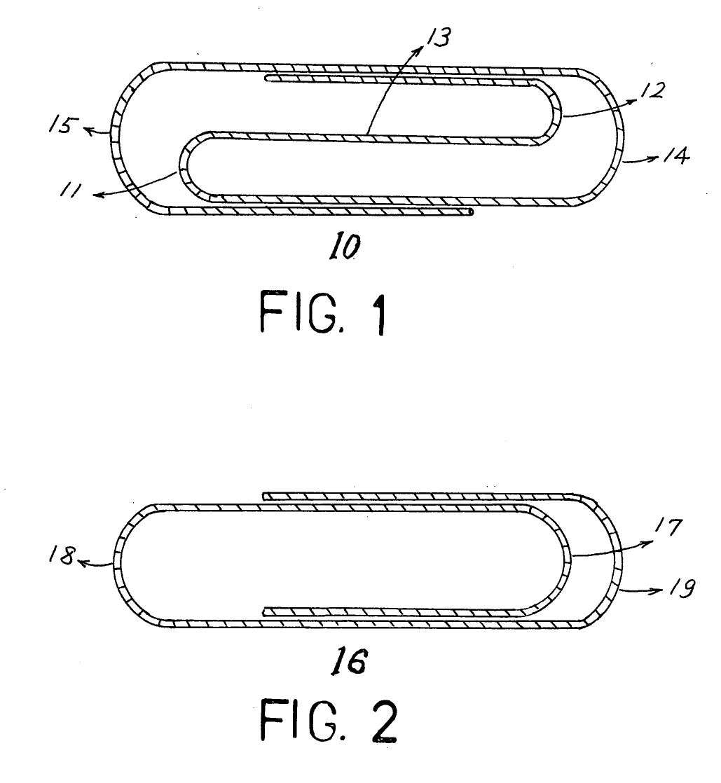

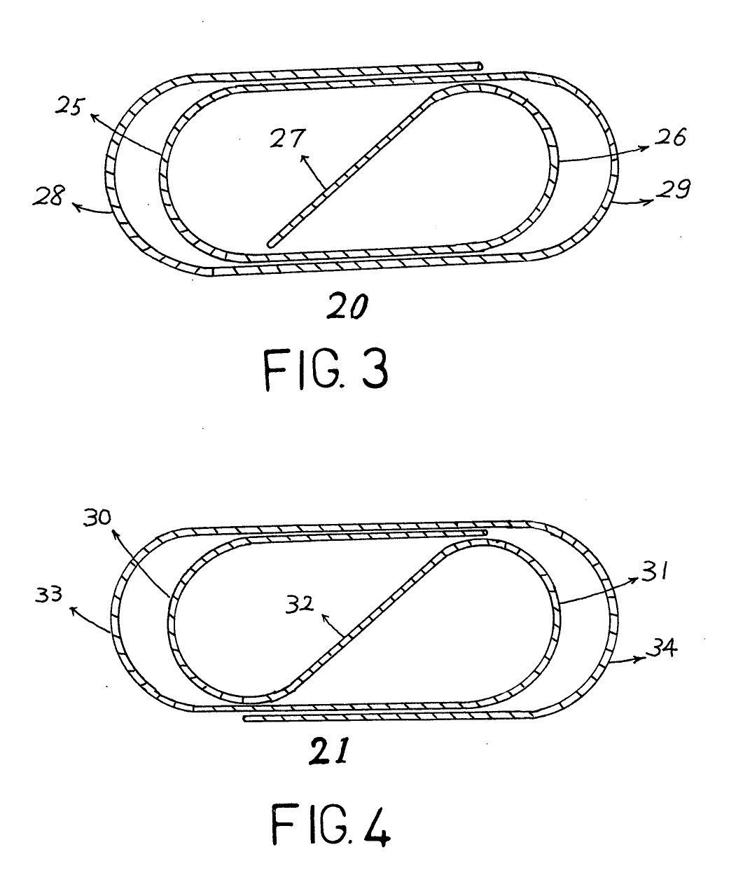

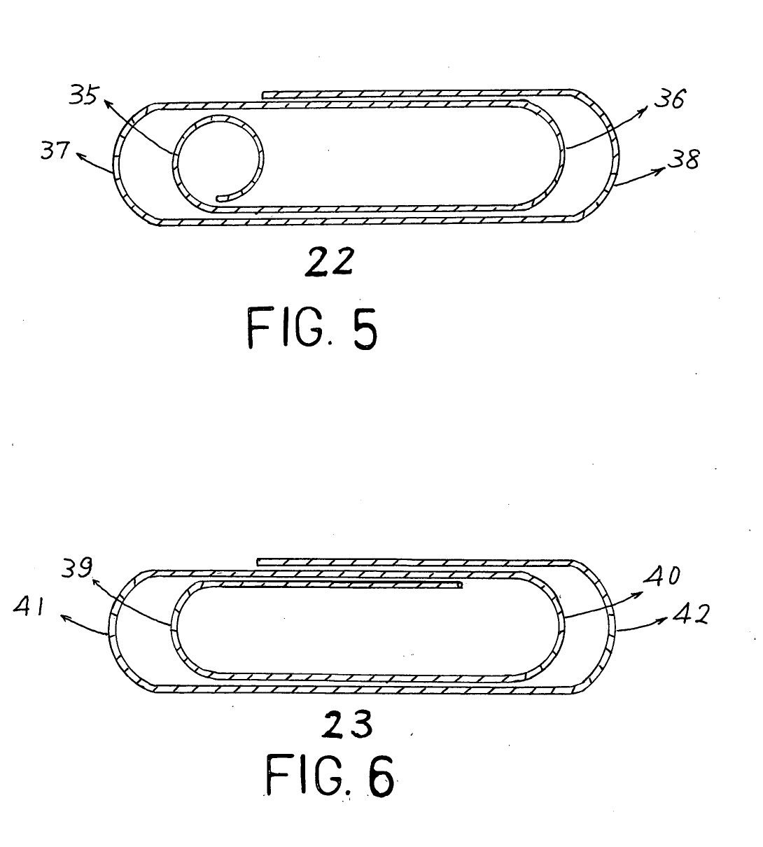

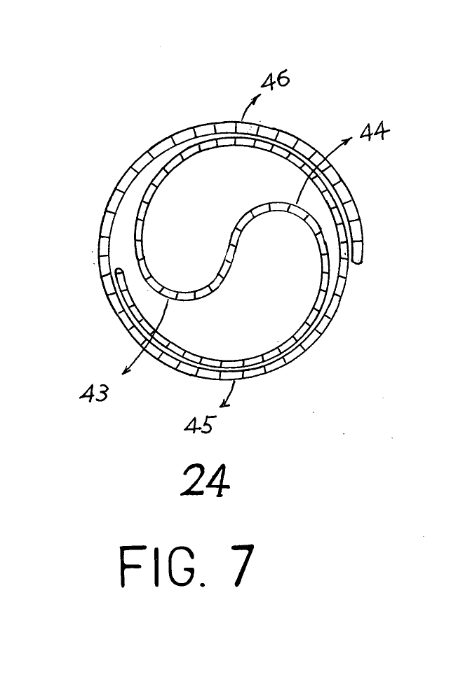

Referring now in detail to the drawing numeral 10 of FIG. 1 is a paper clip with dual central wire loops. Paper clip with dual central wire loops 10 of FIG. 1 has two wire loops 11 and 12 in the center. Numeral 13 of FIG. 1 is the mutual central stem of paper clip with dual central wire loops 10. If user grasps a paper clip with dual central wire loops 10 at one end 14 he/she can place the other end 15 under and against a stack of papers and then uses one of his/her fingertips to push up the central mutual stem 13 to open wire loop 11 to clip papers. If user grasps a paper clip with dual central wire loops 10 at the end 15 he/she can places the other end 14 under and against a stack of papers and then uses one of his/her fingertips to push up the central mutual stem 13 to open wire loop 12 to clip papers. Numeral 16 of FIG. 2 is a Jem paper clip that has only one central wire loop 17 in the center. User has to grasp the end 18 and places the other end 19 under and against a stack of papers and then uses one of his/her fingertips to push up and open central wire loop 17 to clip paper. If user grasps the wrong end 19 of Jem paper clip 16 he/she can not open the central wire loop 17 to clip papers. Paper clip with dual central wire loops 10 is of a variety of shapes, such as 20 of FIG. 3, 21 of FIG. 4, 22 of FIG. 5, 23 of FIGS. 6 and 24 of FIG. 7. Numeral 20 of FIG. 3 is another kind of paper clip with dual central wire loops that has two central wire loops 25 and central wire loop 26. Numeral 27 of FIG. 3 is the mutual central stem of central wire loop 25 and central wire loop 26. Central wire loop 25 and central wire loop 26 form a Q-shaped. Paper clip with dual central wire loops 20 has one end 28 and another end 29. User can grasp end 28 or end 29 to clip a stack of papers like he/she does with paper clip with dual central wire loop 10. Numeral 21 of FIG. 4 is another kind of paper clip with dual central wire loop that has two central wire loops 30 and 31. Central wire loop 30 and central wire loop 31 form a S-shaped. Numeral 32 of FIG. 4 is the mutual stem of central wire loop 30 and central wire loop 31. Paper wire loop with dual central wire loop 21 has two ends, 33 and 34. User can grasp end of 33 or 34 to clip papers like he/she does with paper clip with dual central wire loop 10. Numeral 22 of FIG. 5 is another kind of paper clip with dual central wire loop that has two central wire loops 35 and 36 and two ends 37 and 38. The central loop 35 of FIG. 5 is a circle-shaped loop. User can use it like he/she does with a Jem clip but at either end 37 or 38. Numeral 23 of FIG. 6 is another kind of, paper clip with dual central wire loop that has two central wire loops 39 and 40 and two ends 41 and 42. User can use it like he/she does with Jem clip but at either end 41 or 42. Numeral 24 of FIG. 7 is another kind of paper clip with dual central wire loop that has two central wire loops 43 and 44 and two circular ends 45 and 46. User can use it like he/she does with paper clip with dual central clip 10.

1. A paper clip with dual central wire loops paper clip comprising a large outer elongated oval-shaped wire loop, two U-shaped central wire loops and a mutual central stem.

2. The said a large outer elongated oval-shaped wire loop in claim 1 embraces the said two U-shaped central wire loops and connects at one end to one end of one of the said two U-shaped central wire loops in claim 1.

3. Each one of the said two U-shaped central wire loops in claims 1 and 2 consists of a wire loop and two stems like a U shape.

4. The said two U-shaped central wire loops in claims 1, 2 and 3 connect together by the said mutual central stem in claim 1 to form S shape.

5. The said two U-shaped central wire loops in claims 1, 2, 3 and 4 share the said mutual central stem in claims 1 and 4 as their central stem like the middle stem of a letter of S.

6. The apex of any one U-shaped loop of the said two U-shaped central wire loops in claims 1, 2, 3, 4 and 5 points outward.

7. The said mutual central stem in claims 1, 4 and 5 connects together the said two U-shaped central wire loops in claims 1, 2, 3, 4, 5 and 6 like the central stem of a letter of S connects its upper U and its lower U.
